(19) United States
(12) Patent Application Publication
(10) Pub. No.: US 2026/0192795 A1
(43) Pub. Date: Jul. 9, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventors: Tatsuya SUGANO, Seto-shi (JP); Hidenobu KINUGASA, Nagoya-shi (JP); Takahiro YAMAMOTO, Toyota-shi (JP)

(73) Assignee: TOYOTA JIDOSHA KABUSHIKI KAISHA, Toyota-shi (JP)

(21) Appl. No.: 19/384,844

(22) Filed: Nov. 10, 2025

(30) Foreign Application Priority Data
Jan. 9, 2025 (JP) 2025-003680

(51) Int. Cl. B60W 30/06; B60W 60/00

(52) U.S. Cl. CPC B60W 30/06; B60W 60/0021; B60W 2555/20; B60W 2556/10

(57) ABSTRACT

The processing circuit included in the automated valet parking system acquires the environment information for each section in the parking lot in which the automated valet parking is performed, and determines whether or not there is a non-permitted section in which the operation control based on the sensing information of the in-vehicle sensor is not permitted based on the environment information for each section. Further, the processing circuit generates a travel route for guiding the vehicle to the destination using the sensing information of the infrastructure sensor. When there is a plurality of candidates for the travel route, the processing circuit preferentially selects a travel route having a smaller number of non-permitted sections.

### CROSS-REFERENCE TO RELATED APPLICATION

This application claims priority to Japanese Patent Application No. 2025-003680 filed on January 9, 2025. The disclosure of the above-identified application, including the specification, drawings, and claims, is incorporated by reference herein in its entirety.

### BACKGROUND

### 1. Technical Field

The present disclosure relates to an automated valet parking system and an automated valet parking method.

### 2. Description of Related Art

Japanese Unexamined Patent Application Publication No. 2021-84626 (JP 2021-84626 A) discloses a technique in which when an infrastructure that supports automated valet parking receives a parking request from a vehicle, the infrastructure checks whether a sensor mounted on the vehicle operates normally, checks whether required operation required for the automated valet parking is performed by the vehicle, and determines whether the automated valet parking can be performed for the vehicle based on the check results.

### SUMMARY

In-vehicle sensors have different sensitivities among vehicles. Therefore, stop control may be unnecessarily activated by the in-vehicle sensors in some vehicles, making it difficult to continue the automated valet parking, or affecting the following vehicles. In addition, each in-vehicle sensor may not operate well in some weather conditions, depending on the characteristics of the in-vehicle sensor. Therefore, there is a possibility of hindering automated valet parking based on information sensed by an in-vehicle sensor under weather conditions in which the in-vehicle sensor does not operate well.

An aspect of the present disclosure provides an automated valet parking system that provides automated valet parking to a target vehicle, including a processing circuit. The processing circuit acquires environment information for each section in a parking lot in which the automated valet parking is performed, and determines based on the environment information for each section whether there is a non-permitted section in which operation control based on information sensed by an in-vehicle sensor is not permitted. In addition, the processing circuit generates a travel route for guiding the target vehicle to a destination using information sensed by an infrastructure sensor. When there is a plurality of candidates for the travel route, the processing circuit preferentially selects a travel route with a shorter non-permitted section.

An aspect of the present disclosure provides an automated valet parking method by which a computer provides automated valet parking to a target vehicle, the automated valet parking method including the following processes to be executed by the computer. A first process includes acquiring environment information for each section in a parking lot in which the automated valet parking is performed. A second process includes determining based on the environment information for each section whether there is a non-permitted section in which operation control based on information sensed by an in-vehicle sensor is not permitted. A third process includes generating a travel route for guiding the target vehicle to a destination using information sensed by an infrastructure sensor. A fourth process includes when there is a plurality of candidates for the travel route, preferentially selecting a travel route with a shorter non-permitted section.

According to the present disclosure, it is determined based on the environment information for each section in the parking lot whether there is a non-permitted section in which operation control based on information sensed by an in-vehicle sensor is not permitted. When there is a plurality of travel routes generated using information sensed by an infrastructure sensor, a travel route with a shorter non-permitted section is preferentially selected. Accordingly, it is possible to improve the safety of the automated valet parking by effectively using the in-vehicle sensor in addition to using the infrastructure sensor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an automated valet parking system;

FIG. 2 is a diagram for explaining a method of determining a travel route based on operation history information of stop control;

FIG. 3 is a diagram illustrating a method of determining a travel route based on weather conditions;

FIG. 4 is a flowchart illustrating an exemplary process executed in the infrastructure at the beginning of the automated valet parking when the travel route is determined based on the operation history information of the stop control; and

FIG. 5 is a flowchart illustrating an example of a process executed in the infrastructure at the start of automated valet parking when a travel route is determined based on weather conditions.

### DETAILED DESCRIPTION OF EMBODIMENTS

### 1. Configuring an automated valet parking System

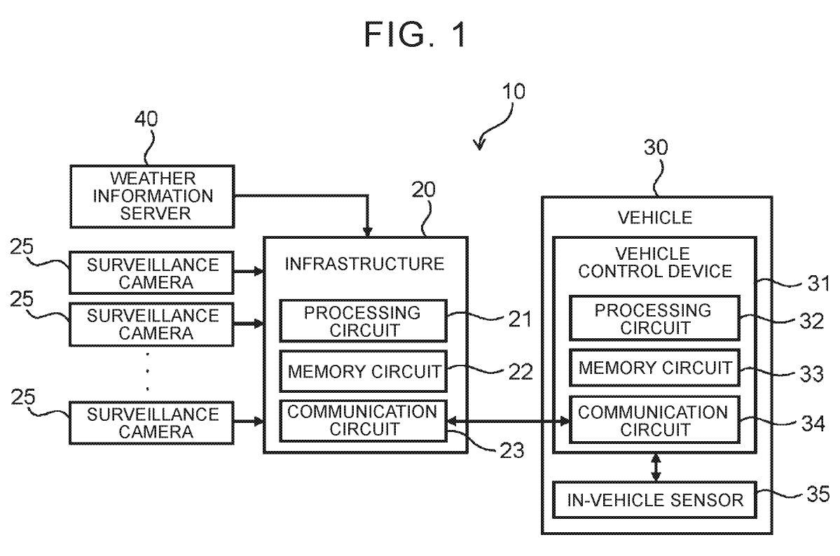

FIG. 1 shows a configuration of an automated valet parking system 10 according to the present embodiment. The automated valet parking system 10 includes an infrastructure 20 that supports automated valet parking, and a vehicle 30 that supports automated valet parking.

Infrastructure 20 is a computer that controls vehicle 30 in a parking lot where automated valet parking system 10 is provided. The infrastructure 20 may be a physical server, a cloud server, or a combination of a physical server and a cloud server. The infrastructure 20 acquires sensing information for automated valet parking from a plurality of infrastructure sensors installed in a parking lot in real time, and performs processing related to automated valet parking based on the sensing information.

A representative example of the infrastructure sensor is a monitoring camera 25 arranged along a road on which the vehicle 30 travels. During automated driving by automated valet parking, the vehicle 30 enters an imaging range of at least one monitoring camera 25. The monitoring camera 25 is disposed at a height such as a ceiling, a wall, a support, and the like, and photographs the vehicle 30 from above. The photographing angle of the monitoring camera 25 may be adjusted so as to photograph the vehicle 30 from directly above, or may be adjusted so as to photograph the vehicle 30 from obliquely forward, obliquely rearward, or obliquely sideways. In addition to the monitoring cameras 25, LiDAR or millimeter-wave radars may be provided as infrastructure sensors.

The infrastructure 20 includes a processing circuit 21, a storage circuit 22, and a communication circuit 23. The processing circuit 21 is a circuit configured to perform processing related to automated valet parking. The sensing information of the infrastructure sensor including the camera image of the monitoring camera 25 is processed by the processing circuit 21. Processing circuit 21 includes one or more processors, such as CPU, FPGA, or ASIC. The storage circuit 22 is a circuit configured to store a program related to automated valet parking and related data thereof. The storage circuit 22 includes one or more primary memories, and may further include one or more secondary storage. The communication circuit 23 is a circuit configured to communicate with the outside. The communication circuit 23 includes a wireless communication module for performing wireless communication and a wired communication module for performing wired communication. The processing circuit 21 is communicably connected to the storage circuit 22 and the communication circuit 23.

The communication circuit 23 is connected to the weather information server 40 provided by the weather information providing company. The infrastructure 20 acquires weather conditions when using automated valet parking from the weather information server 40.

The vehicle 30 has a function necessary for automated valet parking including an automated driving function, and is a target vehicle to be subjected to automated valet parking. Automated driving of the vehicle 30 in the parking lot is controlled by cooperation between the infrastructure 20 and the vehicle control device 31 mounted on the vehicle 30. The vehicle 30 may be an autonomous driving vehicle that can autonomously travel outside the parking lot.

The vehicle 30 includes an in-vehicle sensor 35 that senses the surroundings of the vehicle 30. The in-vehicle sensor 35 includes at least one of a camera, a LiDAR, and a millimeter-wave radar. The in-vehicle sensor 35 is communicably connected to the vehicle control device 31. The sensing information obtained by the in-vehicle sensor 35 is processed by the vehicle control device 31.

The vehicle control device 31 includes a processing circuit 32, a storage circuit 33, and a communication circuit 34. The processing circuit 32 is a circuit configured to perform processing related to automated valet parking. Processing circuit 32 may include one or more processors, such as a CPU, FPGA, or ASIC. The storage circuit 33 is a circuit configured to store a program related to automated valet parking and related data thereof. The storage circuit 33 includes one or more primary memories, and may further include one or more secondary storage. The communication circuit 34 is a circuit configured to communicate with the communication circuit 23 of the infrastructure 20. The communication circuit 34 includes a wireless LAN module for performing wireless communication over a wireless LAN. The processing circuit 32 is communicably connected to the storage circuit 33 and the communication circuit 34.

### 2. Function of the vehicle control device

The vehicle control device 31 creates a travel plan based on the sensing information of the in-vehicle sensor 35, and controls the operation of the vehicle 30 in accordance with the travel plan. The motion control includes starting the vehicle 30, accelerating the vehicle 30, decelerating the vehicle 30, stopping the vehicle 30, and steering the vehicle 30. The operation control based on the sensing information of the in-vehicle sensor 35 includes stop control for avoiding collision with an obstacle detected by the in-vehicle sensor 35 or reducing collision damage. The stop control is typically an emergency brake. The vehicle control device 31 sets an operation condition for activating the stop control at the start of the automated valet parking, and activates the stop control when the operation condition is satisfied during the execution of the automated valet parking.

The vehicle control device 31 acquires a control instruction related to the operation control of the vehicle 30 from the infrastructure 20. When the control instruction is acquired, the vehicle control device 31 performs operation control based on both the sensing information of the in-vehicle sensor 35 and the control instruction from the infrastructure 20. When the operation control based on the sensing information of the in-vehicle sensor 35 is malfunctioning, the vehicle control device 31 can perform the operation control in accordance with the control instruction from the infrastructure 20.

### 3. Infrastructure features

Upon receiving a request for automated valet parking from the vehicle 30, the infrastructure 20 determines a travel route for guiding the vehicle 30 to a parking place that is a destination based on the parking lot information. In determining the travel route, the infrastructure 20 acquires environmental information for each section in the parking lot. The environment information includes information on the operation history of the stop control and weather conditions when the automated valet parking is used. The storage circuit 22 of the infrastructure 20 stores a program for determining a travel route based on the operation history information of the stop control, and a program for determining a travel route based on weather conditions when the automated valet parking is used.

When the travel route is determined based on the operation history of the stop control, the infrastructure 20 acquires the vehicle type of the vehicle 30 from the vehicle 30, and further acquires the operation history information of the stop control corresponding to the vehicle type from the storage circuit 22. Vehicle types are categories based on vehicle specifications such as length, width, and minimum radius of rotation. All vehicles are classified into one of a plurality of categories set in advance. The operation history information of the stop control is information related to unnecessary operation of the stop control in each section in the parking lot, which is collected from all vehicles traveling in the parking lot in a predetermined period in the past. The collected operation history information is stored in the storage circuit 22 for each vehicle type. Whether or not the operation of the stop control is unnecessary can be determined from the operation frequency of each section. For example, if the probability that a collision is likely to occur is uniform across the entire area of the parking lot, when the operation frequency is high in the specific section, it can be determined that the operation of the stop control in the specific section is an unnecessary operation. Details of the method of determining the travel route based on the operation history of the stop control will be described later.

When the travel route is determined based on the weather condition, the infrastructure 20 acquires the weather condition at the time of use of the automated valet parking from the weather information server 40, and also acquires the in-vehicle sensor information regarding the type of the in-vehicle sensor 35 from the vehicle 30. Depending on the combination of the weather conditions and the type of the in-vehicle sensor 35, there is a possibility that effective sensing information cannot be obtained by the in-vehicle sensor 35. For example, the camera of the in-vehicle sensor 35 may have low effectiveness in backlight, snowfall, and rainfall. LiDAR of the in-vehicle sensor 35 may be less effective when mist is emitted, when it rains, and when it snows. Details of a method of determining a travel route based on weather conditions will be described later.

The infrastructure 20 generates a control instruction so that the vehicle 30 can autonomously travel along the travel route based on the sensing information of the infrastructure sensor including the camera image of the monitoring camera 25. Typically, the infrastructure 20 generates, as a control instruction, a waypoint in which data such as target position information, curve information, speed information, and gradient information is defined.

### 3. Method for determining travel route based on operation history information of stop control

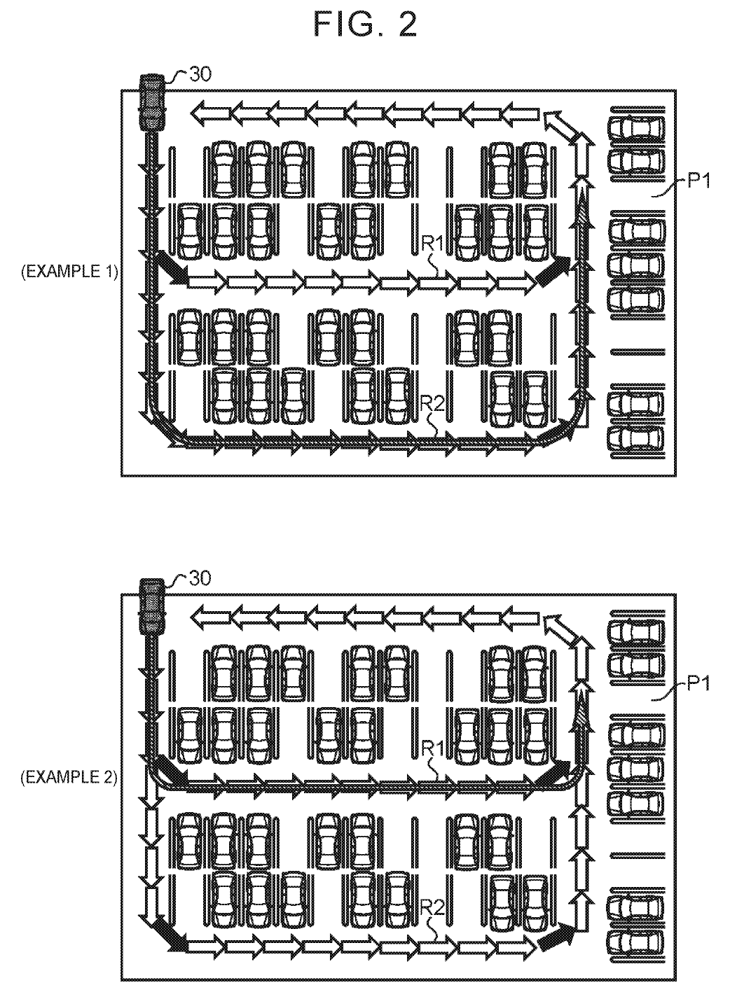

FIG. 2 is an explanatory diagram of a method of determining a travel route based on operation history information of stop control. In FIG. 2, a flow line when the vehicle 30 autonomously travels by automated valet parking in a parking lot is indicated by a plurality of arrow lines. Each arrow line represents one section of the travel route. The length of each section can be arbitrarily set. When the vehicles 30 enter the parking lot, the infrastructure 20 calculates a travel route to the parking location P1 based on the parking lot data.

In the embodiments illustrated in FIG. 2, the infrastructure 20 calculates the first travel route R1 and the second travel route R2 as candidates for the travel route up to the parking location P1. The first travel route R1 is a route passing through the inside of the parking lot, and the second travel route R2 is a route passing through the outside of the parking lot. The infrastructure 20 determines a possibility that unnecessary operation of the stop control occurs in the vehicle 30 for each section based on the operation history information. In a section in which the possibility of the unnecessary operation of the stop control is high, the operation control based on the sensing information of the in-vehicle sensor 35 is turned off.

The section of the white arrow line among the sections constituting each travel route indicates a section in which the operation control based on the sensing information of the in-vehicle sensor 35 is on. The section of the black arrow line indicates a section in which the operation control based on the sensing information of the in-vehicle sensor 35 is off, that is, a non-permitted section in which the operation control is not permitted. The infrastructure 20 determines the travel route having the smallest non-permitted section as the travel route of the vehicle 30. The route of the hatched arrow line indicates the travel route ultimately determined by the infrastructure 20.

In the first embodiment, there are two sections in the first travel route R1 and one section of a black arrow line in the second travel route R2. Therefore, the infrastructure 20 determines the second travel route R2 as a travel route to the parking location P1 of the vehicle 30.

In the second case, there are two sections of the arrow line which is black in the first travel route R1 and two sections in the second travel route R2. When there is a plurality of travel routes in which the number of unauthorized sections in which the operation control based on the sensing information of the in-vehicle sensor 35 is not permitted is the same, the infrastructure 20 selects the travel route with the shortest distance to the destination. Therefore, the infrastructure 20 determines the first travel route R1 as a travel route to the parking location P1 of the vehicle 30.

### 4. Method for determining a travel route based on weather conditions

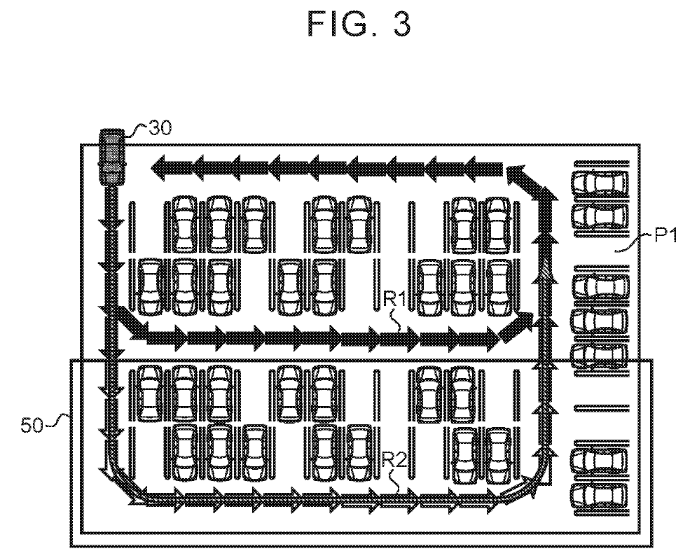

FIG. 3 is an explanatory diagram of a method of determining a travel route based on weather conditions. In the embodiment illustrated in FIG. 3, it is assumed that the in-vehicle sensor 35 is a LiDAR, and a part of the parking lot is a fog outside the building 50 in the building 50. The vehicle control device 31 divides each travel route R1, R2 into a plurality of sections, and determines the effectiveness of the in-vehicle sensor 35 for each section of each travel route R1, R2. Since LiDAR is vulnerable to fog, it is determined that the in-vehicle LiDAR is valid in a section in the building 50, but in a section outside the building 50, it is determined that the in-vehicle LiDAR is not useful.

The infrastructure 20 determines, as the travel route of the vehicle 30, a travel route having the smallest unauthorized section in which the motion control based on the sensing information of the in-vehicle sensor 35 is not permitted. The route of the hatched arrow line indicates the travel route ultimately determined by the infrastructure 20. In the embodiment illustrated in FIG. 3, the infrastructure 20 determines the first travel route R1 as a travel route to the parking location P1 of the vehicle 30.

### 5. Processing performed by the infrastructure

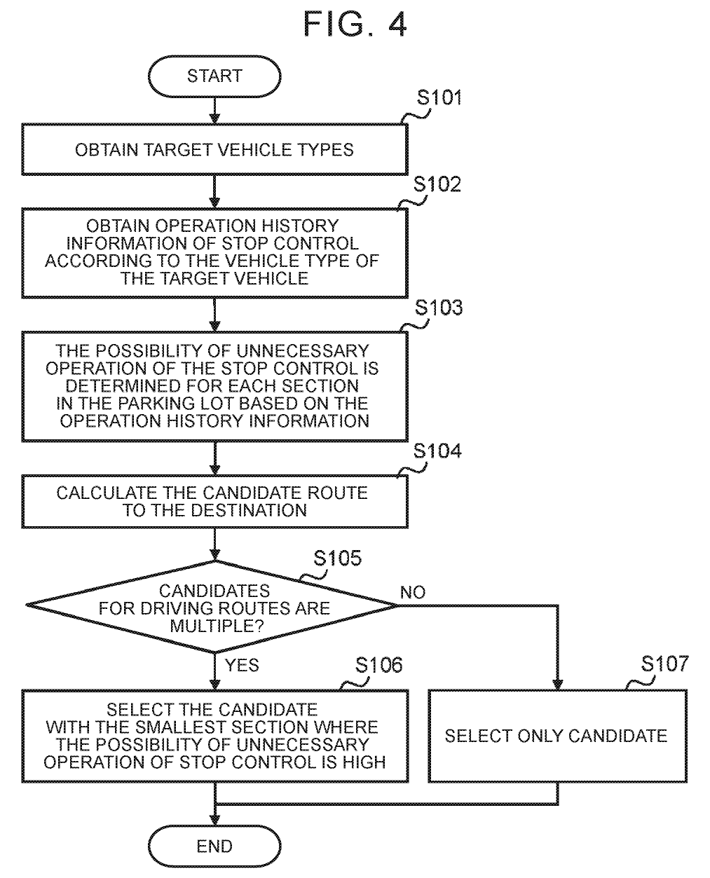

FIG. 4 is a flowchart illustrating an example of a process executed by the infrastructure 20 at the start of automated valet parking when the travel route is determined based on the operation history information of the stop control. Specifically, the processing illustrated in this flowchart is executed by the processing circuit 21 of the infrastructure 20.

In S101, the infrastructure 20 communicates with the vehicle control device 31 of the vehicle 30 and acquires the vehicle type of the vehicle 30 stored in the storage circuit 33 of the vehicle control device 31. In the storage circuit 22 of the infrastructure 20, the operation history information of the stop control is stored for each vehicle type. In S102, the infrastructure 20 searches the storage circuit 22 using the vehicle type of the vehicle 30 as a search criterion, and acquires the operation history data of the stopping control according to the vehicle type. In S103, the infrastructure 20 calculates, for each section in the parking lot, a possibility that the stop control is unnecessarily operated based on the operation history of the stop control acquired in S102. For example, in a section in which the frequency of unnecessary operation was high in the past, there is a high possibility that the stop control is unnecessarily operated this time as well. The infrastructure 20 determines a section in which the frequency of unnecessary operation exceeds a threshold as a section in which the possibility of unnecessary operation of the stop control is high.

In S104, the infrastructure 20 calculates the candidates of the travel routes to the destination based on the parking lot data. The destination at the time of warehousing is a parking place, and a candidate of a travel route from the entrance to the parking place is calculated. The destination at the time of retrieval is an exit, and a candidate of a travel route from the parking place to the exit is calculated. The number of candidates for the travel route may be plural or one depending on the positional relationship between the departure point and the destination.

In S105, a determination is made as to whether the number of candidates for the travel route is plural or one. If there is a plurality of driving route candidates, the process by the infrastructure 20 proceeds to S106. In S106, the infrastructure 20 determines that the section in which the possibility of the unnecessary operation of the stopping control is high is the non-permitted section in which the operation control based on the in-vehicle sensor 35 is not permitted, and selects the candidate with the smallest non-permitted section as the travel route to the destination. If there is only one candidate driving route, the process by the infrastructure 20 proceeds to S107. In S107, the infrastructure 20 selects the only candidates that exist as the travel route to the destination.

When the above-described processing is executed by the infrastructure 20, at the start of the automated valet parking, a travel route in which a section in which the stop control by the in-vehicle sensor is unnecessarily operated is preferentially selected. Accordingly, in addition to the use of the infrastructure sensor including the monitoring camera 25, the safety of the automated valet parking can be improved by effectively using the in-vehicle sensor 35.

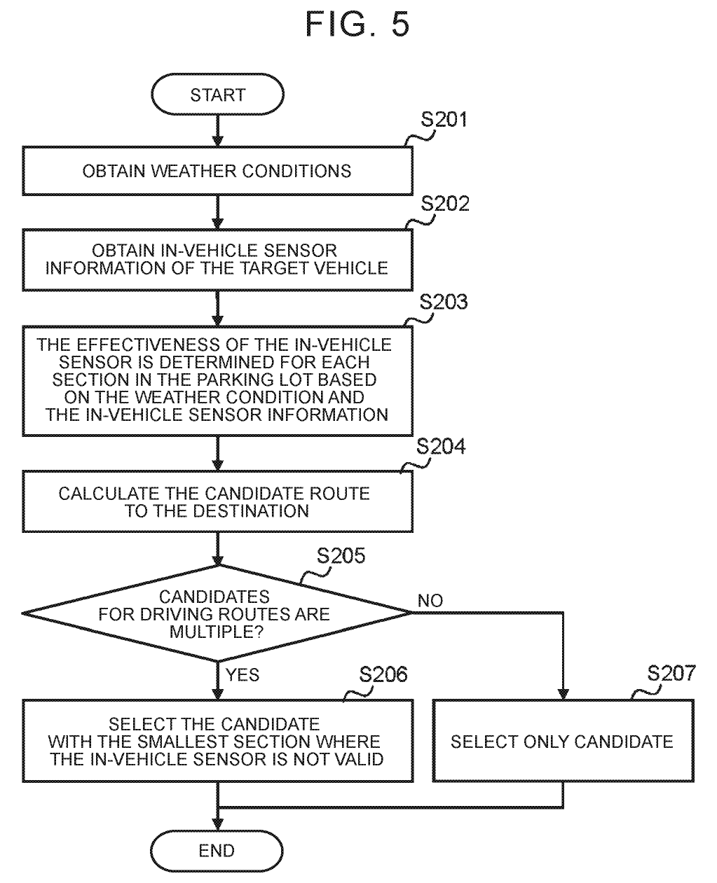

FIG. 5 is a flowchart illustrating an example of a process executed by the infrastructure 20 at the start of automated valet parking when a travel route is determined based on weather conditions. Specifically, the processing illustrated in this flowchart is executed by the processing circuit 21 of the infrastructure 20.

In S201, the infrastructure 20 communicates with the weather information server 40 and obtains the weather conditions of the parking lot from the weather information server 40. In addition, in S202, the infrastructure 20 communicates with the vehicle control device 31 of the vehicle 30, and acquires the in-vehicle sensor data of the vehicle 30 stored in the storage circuit 33 of the vehicle control device 31. In S203, the infrastructure 20 calculates the effectiveness of the in-vehicle sensor 35 for each section in the parking lot on the basis of the weather conditions acquired by S201 and the in-vehicle sensor information acquired by S202.

In S204, the infrastructure 20 calculates the candidates of the travel routes to the destination based on the parking lot data. In S205, a determination is made as to whether the number of candidates for the travel route is plural or one. When there are a plurality of candidates for the travel route, in S206, the infrastructure 20 determines that the section in which the in-vehicle sensor 35 is not valid is the non-permitted section in which the operation control based on the in-vehicle sensor 35 is not permitted, and selects the candidate having the smallest non-permitted section as the travel route to the destination. If there is only one candidate driving route, the process by the infrastructure 20 proceeds to S207. In S107, the infrastructure 20 selects the only candidates that exist as the travel route to the destination.

When the above-described processing is executed by the infrastructure 20, a travel route having fewer sections in which the in-vehicle sensor is not effectively operated is preferentially selected. Accordingly, in addition to the use of the infrastructure sensor including the monitoring camera 25, the safety of the automated valet parking can be improved by effectively using the in-vehicle sensor 35.

What is claimed is:

1. An automated valet parking system that provides automated valet parking to a target vehicle, comprising a processing circuit, wherein the processing circuit is configured to:
acquire environment information for each section in a parking lot in which the automated valet parking is performed;
determine based on the environment information for each section whether there is a non-permitted section in which operation control based on information sensed by an in-vehicle sensor is not permitted;
generate a travel route for guiding the target vehicle to a destination using information sensed by an infrastructure sensor; and
when there is a plurality of candidates for the travel route, preferentially select a travel route with a shorter non-permitted section.

2. The automated valet parking system according to claim 1, wherein:
the environment information includes activation history information on stop control based on the information sensed by the in-vehicle sensor acquired from a plurality of vehicles having traveled in the parking lot; and
the processing circuit is configured to determine a possibility of unnecessary activation of the stop control for each section based on the activation history information, and determine a section having a high possibility of unnecessary activation of the stop control as the non-permitted section.

3. The automated valet parking system according to claim 1, wherein:
the environment information includes a weather condition; and
the processing circuit is configured to determine effectiveness of the in-vehicle sensor for each section based on the weather condition, and determine a section in which the in-vehicle sensor is not effective as the non-permitted section.

4. The automated valet parking system according to claim 1, wherein the processing circuit is configured to preferentially select a travel route having a shorter distance to the destination when the non-permitted section has an equal distance.

5. An automated valet parking method by which a computer provides automated valet parking to a target vehicle, the automated valet parking method comprising:
acquiring environment information for each section in a parking lot in which the automated valet parking is performed;
determining based on the environment information for each section whether there is a non-permitted section in which operation control based on information sensed by an in-vehicle sensor is not permitted;
generating a travel route for guiding the target vehicle to a destination using information sensed by an infrastructure sensor; and
when there is a plurality of candidates for the travel route, preferentially selecting a travel route with a shorter non-permitted section.
